(19) United States
(12) Patent Application Publication
(10) Pub. No.: US 2026/0040346 A1
(43) Pub. Date: Feb. 5, 2026

(54) CHANNEL SWITCHING CONDITIONS FOR NON-PRIMARY CHANNEL ACCESS (NPCA)

(71) Applicant: NEWRACOM, Inc., Irvine, CA (US)

(72) Inventors: Si-Chan NOH, Seoul (KR); Joonsoo LEE, Irvine, CA (US)

(73) Assignee: NEWRACOM, Inc., Irvine, CA (US)

(21) Appl. No.: 19/277,154

(22) Filed: Jul. 22, 2025

Related U.S. Application Data
(60) Provisional application No. 63/677,973, filed on Jul. 31, 2024.
(60) Provisional application No. 63/685,138, filed on Aug. 20, 2024.

(51) Int. Cl. H04W 74/00

(52) U.S. Cl. CPC H04W 74/002

(57) ABSTRACT

A method is performed by a station (STA). The method includes the steps of receiving, from an access point (AP), an indication of whether to use a preamble detection NPCA channel switching approach or a control frame detection NPCA channel switching approach, overhearing a PPDU transmitted in a primary channel, and determining whether NPCA can be performed in a NPCA primary channel during transmission of the PPDU using the preamble detection NPCA channel switching approach or the control frame detection NPCA channel switching approach depending on the indication received from the AP.

### CROSS-REFERENCE TO RELATED APPLICATION

This application claims the benefit of U.S. Provisional Application No. 63/685,138, filed Aug. 20, 2024, and U.S. Provisional Application No. 63/677,973, filed Jul. 31, 2024, both titled “Channel switching conditions for Non-Primary Channel Access (NPCA)”, which are hereby incorporated by reference.

### TECHNICAL FIELD

The present disclosure generally relates to wireless communications, and more specifically, relates to non-primary channel access (NPCA) channel switching.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

Non-primary channel access (NPCA) is a technology that allows NPCA-capable wireless devices to transmit in a non-primary channel when the primary channel is occupied by overlapping basic service set (OBSS) signals.

NPCA-capable wireless devices may determine whether to switch to the non-primary channel (which may be referred to as NPCA channel switching) based on information included in an overheard OBSS physical layer protocol data unit (PPDU). Different NPCA-capable wireless devices may have different abilities to decode a PPDU depending on the network topology. For example, some NPCA-capable wireless devices may be able to decode both the preamble and data payload of a PPDU but other NPCA-capable wireless devices may only be able to decode the preamble. If the information needed for making the NPCA channel switching decision is included in the data payload of a PPDU, the coverage imbalance may cause some NPCA-capable wireless devices to switch to the NPCA primary channel and other NPCA-capable wireless devices to remain on the primary channel. The NPCA-capable wireless devices may mistakenly assume that the other NPCA-capable wireless devices made the same NPCA channel switching decision as itself and attempt to communicate with each other based on their own NPCA channel switching decision (e.g., NPCA-capable wireless devices that decided to switch to the NPCA channel may attempt to communicate with other wireless devices in the NPCA primary channel, whereas NPCA-capable wireless devices that decided to remain on the primary channel may attempt to communicate with other wireless devices in the primary channel). However, the communications may be unsuccessful because of the differing NPCA channel switching decisions made by different NPCA-capable wireless devices. This may result in unnecessary transmissions and power consumption.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing the overall concept of NPCA, according to some embodiments.

FIG. 11 is a diagram showing a non-HT PPDU format and modulation schemes that can be used for modulating different parts of the PPDU, according to some embodiments.

FIG. 12 is a diagram showing the coverage imbalance issue, according to some embodiments.

FIG. 13 is a diagram showing an example of a preamble detection NPCA channel switching approach, according to some embodiments.

FIG. 14 is a diagram showing an example of a control frame detection NPCA channel switching approach, according to some embodiments.

FIG. 15 is a flow diagram of a method for determining a NPCA channel switching approach to use, according to some embodiments.

FIG. 16 is a diagram showing operations for determining whether NPCA can be performed during transmission of a PPDU using a preamble detection NPCA channel switching approach, according to some embodiments.

FIG. 17 is a diagram showing operations for determining whether NPCA can be performed during transmission of a PPDU using a control frame detection NPCA channel switching approach, according to some embodiments.

FIG. 18 is a diagram showing operations for determining whether NPCA can be performed during transmission of a PPDU using a preamble detection and control frame detection NPCA channel switching approach, according to some embodiments.

### DETAILED DESCRIPTION

The present disclosure generally relates to wireless communications, and more specifically, relates to non-primary channel access (NPCA) channel switching.

As mentioned above, a coverage imbalance issue in a wireless network can cause different NPCA-capable wireless devices to make differing NPCA channel switching decisions, resulting in unnecessary transmissions and power consumption.

The present disclosure introduces a solution that allows NPCA-capable wireless devices to make more consistent/uniform NPCA channel switching decisions. According to some embodiments, an access point (AP) transmits an indication to stations (STAs) of whether the STAs should use a preamble detection NPCA channel switching approach or a control frame detection NPCA channel switching approach. When a STA overhears a PPDU transmitted in the primary channel, the STA may determine whether it can perform NPCA in the NPCA primary channel during the transmission of the PPDU using the preamble detection NPCA channel switching approach or the control frame detection NPCA channel switching approach, depending on the indication received from the AP.

When using the preamble detection NPCA channel switching approach, the STA may determine whether the PPDU has a PPDU format that provides the necessary NPCA channel switching information in a preamble of the PPDU. The necessary NPCA channel switching information may be information that the STA needs to be able to perform NPCA such as basic service set (BSS) color information and transmission opportunity (TXOP) duration information. Having the BSS color information may allow the STA to determine whether the overheard PPDU is an OBSS PPDU or not (and thus whether NPCA is possible). Having the TXOP duration information may allow the STA to determine how long NPCA can be performed for. If the STA determines that the PPDU has a PPDU format that provides the necessary NPCA channel switching information, the STA may determine whether NPCA can be performed based on the necessary NPCA channel switching information included in the preamble of the PPDU. However, if the STA determines that the PPDU does not have a PPDU format that provides the necessary NPCA channel switching information, the STA may decide not to perform NPCA (and thus not switch to the NPCA primary channel but remain on the primary channel).

When using the control frame detection NPCA channel switching approach, the STA may determine whether the PPDU carries an initial control frame (ICF) or initial control response frame (ICR). The ICF and ICR may be control frames that include the necessary NPCA channel switching information and be modulated using the same modulation scheme (or more reliable modulation scheme) as the preamble of the PPDU. If the STA determines that the PPDU carries an ICF or ICR, the STA may determine whether NPCA can be performed based on the necessary NPCA channel switching information included in the ICF or ICR. However, if the STA determines that the PPDU does not carry an ICF or ICR, the STA may decide not to perform NPCA (and thus not switch to the NPCA primary channel but remain on the primary channel).

In an embodiment, the STA uses a preamble and control frame detection NPCA channel switching approach, which may be a combination of the preamble detection NPCA channel switching approach and the control frame detection NPCA channel switching approach. When using the preamble and control frame detection NPCA channel switching approach, the STA may determine whether the preamble of the PPDU includes the necessary NPCA channel switching information. If the preamble includes the necessary NPCA channel switching information, the STA may determine whether NPCA can be performed based on the necessary NPCA channel switching information included in the preamble. If the preamble does not include the necessary NPCA channel switching information, the STA may determine whether the data payload of the PPDU (e.g., a control frame carried in the PPDU) includes the necessary NPCA channel switching information. If the data payload includes the necessary NPCA channel switching information, the STA may determine whether NPCA can be performed based on the necessary NPCA channel switching information included in the data payload. If the data payload does not include the necessary NPCA channel switching information, the STA may decide not to perform NPCA (and thus not switch to the NPCA primary channel but remain on the primary channel).

The solution described herein allows NPCA-capable wireless devices to make more consistent/uniform NPCA channel switching decisions, and thus prevent unnecessary transmissions and power consumption.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

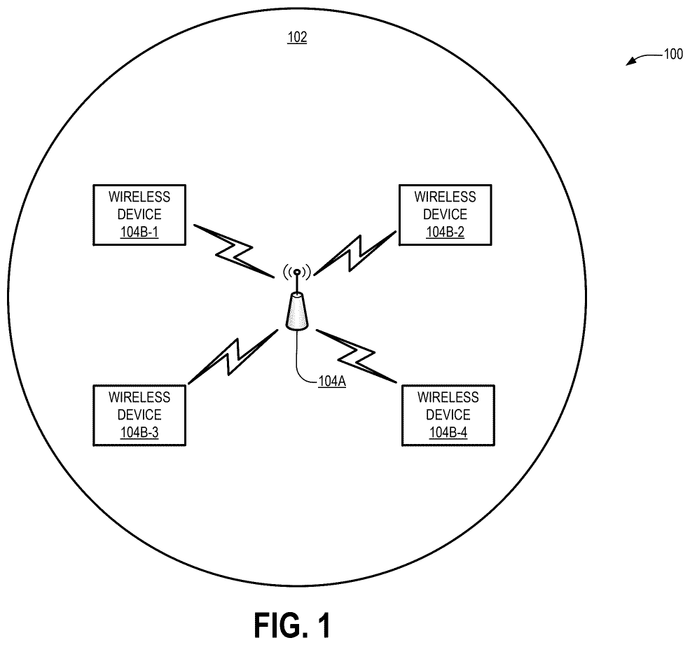

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for case of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

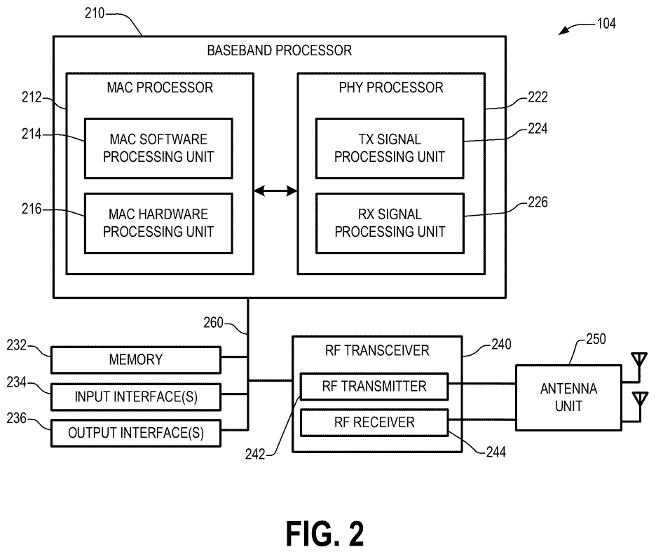

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

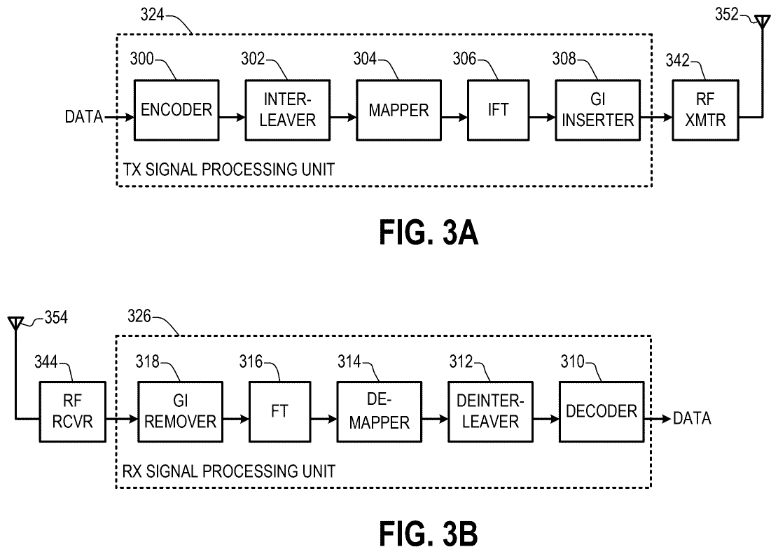

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or ls. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

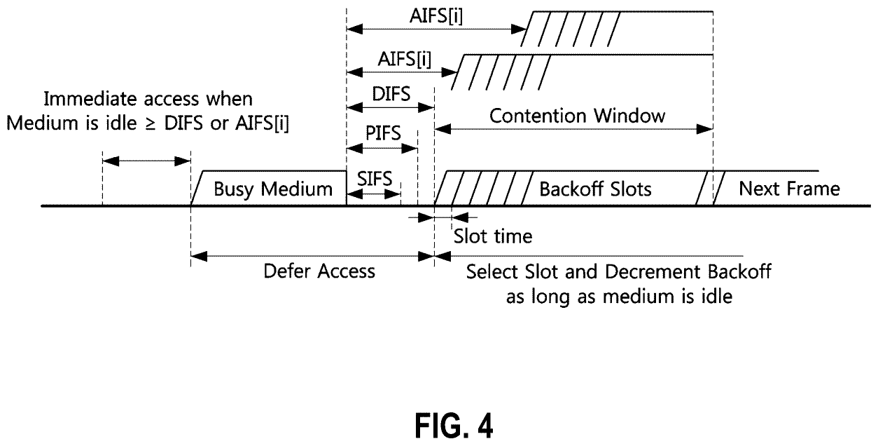

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

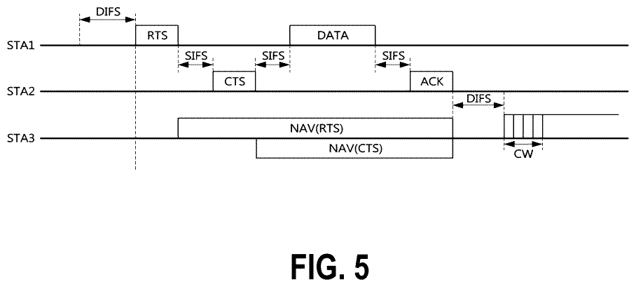

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 docs not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

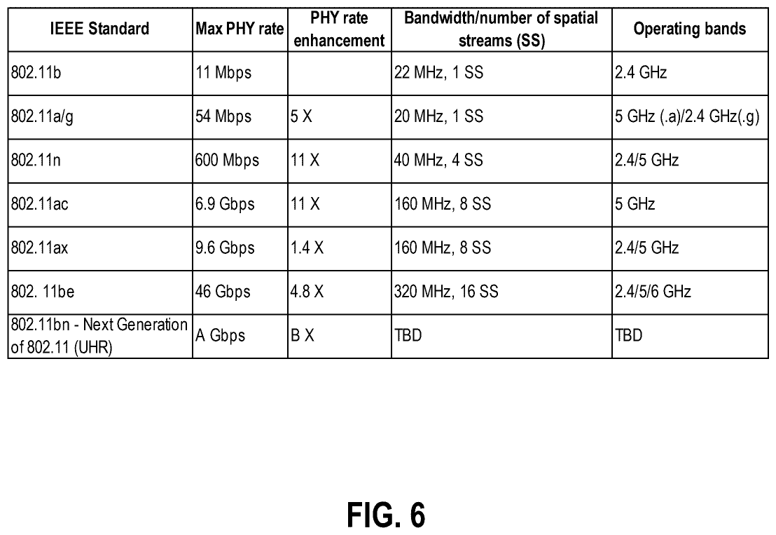

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

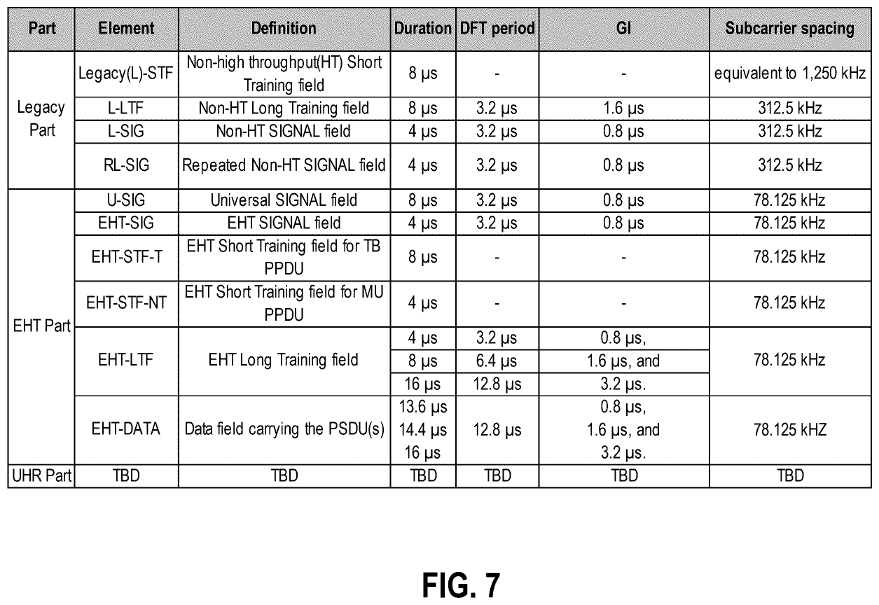

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANS, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

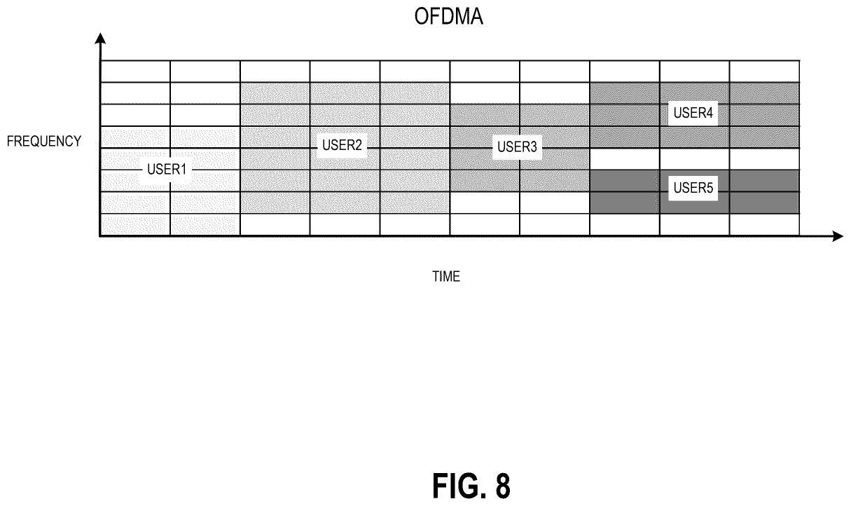

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

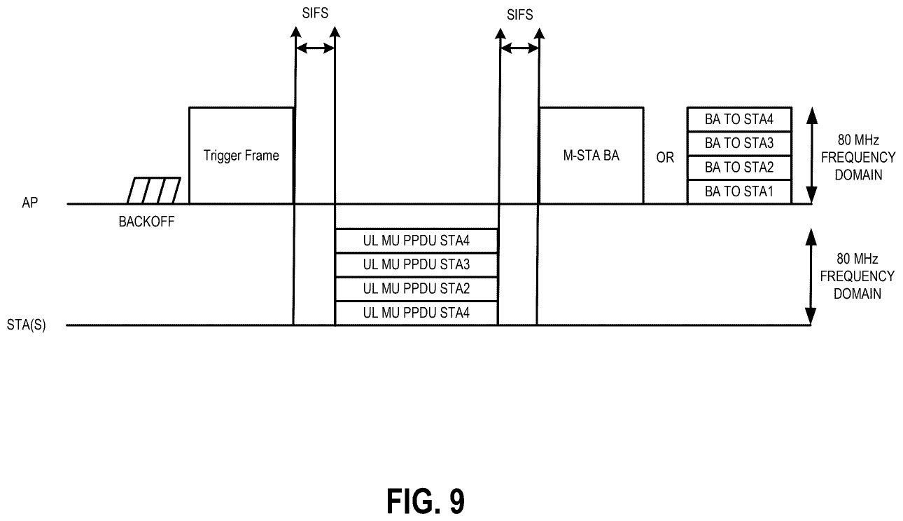

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block

Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

In the existing IEEE 802.11 wireless networking standard, transmission of a PPDU is not allowed if the primary channel is busy. However, with the increase in the operating bandwidth (e.g., to 320 MHz) in more recent IEEE 802.11 wireless networking standards, the rule requiring that the primary channel be idle for PPDU transmission can result in the inefficient usage of bandwidth resources.

For example, consider an AP and a non-AP STA that have an operating bandwidth of 160 MHz. The AP and non-AP STA may check the channel condition prior to attempting a PPDU transmission and find that the 20 MHz primary channel is busy but that the remaining 140 MHz of the operating bandwidth is idle. However, despite the 140 MHz band being idle, the AP and non-AP STA are not allowed to transmit PPDUs because the 20 MHz primary channel is busy. Thus, even though 140 MHz out of the 160 MHz operating bandwidth is idle, it cannot be utilized. Prohibiting transmission when the primary channel is busy may result in the inefficient usage of bandwidth resources, especially as the operating bandwidth increases.

The concept of NPCA has been proposed to address this inefficiency. With NPCA, transmission and reception can be performed in an idle non-primary channel (e.g., a secondary channel) when the primary channel is busy. That is, even when the primary channel is busy (e.g., it is occupied by OBSS signals), if there is a non-primary channel that is idle, NPCA allows transmission/reception in the idle non-primary channel.

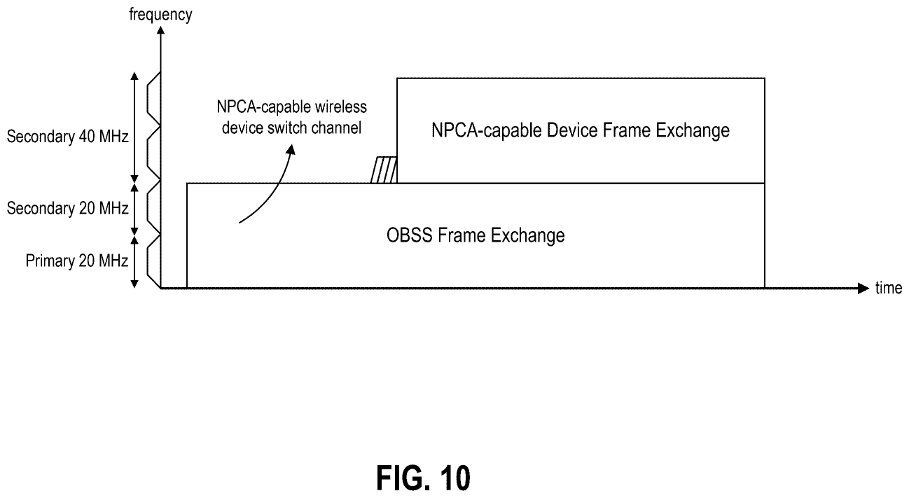

FIG. 10 is a diagram showing the overall concept of NPCA, according to some embodiments.

The diagram shows the overall concept of NPCA when the operating bandwidth is 80 MHz. It should be appreciated, however, that NPCA is not limited to being used with an 80 MHz operating bandwidth but can be used with other operating bandwidth sizes. In this example, the 80 MHz operating bandwidth includes a primary 20 MHz (P20) channel, a secondary 20 MHz (S20) channel, and a secondary 40 MHz (S40) channel.

As shown in the diagram, an OBSS frame exchange may occupy the primary 20 MHz channel and the secondary 20 MHz channel. According to existing IEEE 802.11 wireless networking standard rules, wireless devices are not allowed to attempt transmission when OBSS signals occupy the primary channel. However, with NPCA, NPCA-capable wireless devices may switch to a non-primary/secondary channel (e.g., the secondary 40 MHz channel) and attempt transmission in the secondary channel after performing backoff. Thus, NPCA-capable wireless devices may perform a frame exchange in the secondary channel while the OBSS frame exchange occurs in the primary 20 MHz channel, thereby making use of otherwise idle bandwidth resources.

For a wireless device to perform NPCA, the following considerations should be addressed. The wireless device should determine the band in which NPCA can be performed (the NPCA band). Also, the wireless device should identify the NPCA primary channel within the NPCA band that will perform a role similar to the existing primary channel. Also, the wireless device should decide whether it can perform NPCA regardless of the type or kind of OBSS frame (e.g., the OBSS frame can be a data frame, management frame, control frame, etc.) if the OBSS frame occupies the primary channel. Also, if the wireless device determines that NPCA can be performed, it should determine the duration for which NPCA can be performed (the NPCA duration). To perform NPCA efficiently, rules regarding the above-mentioned considerations are necessary.

To perform successful NPCA, NPCA-capable wireless devices should recognize certain information such as information regarding the band in which NPCA can be performed and information regarding which channel within the NPCA band is designated as the NPCA primary channel. Such information may be exchanged between wireless devices (e.g., an AP and non-AP STAs within a BSS) during a negotiation phase (e.g., through beacon frames and/or probe request/response frames). However, even if such information is recognized, NPCA-capable wireless devices may not be able to perform NPCA without ambiguity. This is because NPCA is a feature that is activated when OBSS signals occupy the primary channel. Some of the information required for performing NPCA can only be obtained after overhearing the OBSS signal. Thus, making NPCA switching decisions without overhearing the OBSS signal and extracting information from the OBSS signal can lead to meaningless/unsuccessful NPCA operation. To this end, the present disclosure proposes certain conditions/rules to prevent meaningless NPCA operations in advance.

The following information/recognitions may be needed to be obtained from OBSS signals to successfully perform NPCA.

### OBSS Presence

Since NPCA operates when the primary channel is occupied by an OBSS signal, it is necessary to recognize when the primary channel is occupied by an OBSS signal. This recognition is possible after listening to (overhearing) the OBSS signal.

### NPCA Operation Duration

NPCA-capable wireless devices should not affect the existing protocol when coexisting with legacy wireless devices that are not capable of performing NPCA. For example, assume that the primary channel is occupied by an OBSS signal and a NPCA-capable wireless device switches to the NPCA channel/band to perform NPCA. If the NPCA-capable wireless device attempts to access the NPCA primary channel/band after the OBSS is finished occupying the primary channel, it can affect the existing protocol. For example, if NPCA-capable wireless devices perform NPCA in the NPCA channel/band for an extended period of time, OBSS STAs that have their primary channel within the NPCA band will not be able to occupy the channel due to NPCA operation. This can affect the existing protocol. Thus, NPCA should only be performed until the end of the OBSS signal that triggered the NPCA or until the end of the TXOP held by the OBSS operating in the primary channel. The NPCA duration can only be determined after listening to the OBSS signal.

### Possibility of NPCA Operation

NPCA-capable wireless devices may share information regarding the NPCA band and the NPCA primary channel during a negotiation phase through beacon frames and/or probe request/response frames, as mentioned above. Alternatively, information regarding the NPCA band and the NPCA primary channel may be implicitly determined based on listening to OBSS signals. Even if the NPCA band and NPCA primary channel are predefined, the determination of whether NPCA can be performed has to be made after listening to the OBSS signal. This is because NPCA can only be performed if the OBSS signal occupies the primary channel, which can only be recognized after listening to the OBSS signal.

Having information regarding the OBSS presence, the NPCA duration, and the possibility of NPCA operation can prevent performing meaningless NPCA in advance. However, it may only be effective from the perspective of a single NPCA-capable wireless device. If all NPCA-capable wireless devices do not interpret the information in the same way, NPCA may malfunction. For example, assume a situation where a NPCA-capable AP cannot overhear the OBSS signal occupying the primary channel, but NPCA-capable (non-AP) STAs associated with the AP are able to overhear the OBSS signal occupying the primary channel. In this situation, the AP will not perform NPCA (and remain on the primary channel) because it does not recognize that an OBSS signal is occupying the primary channel. In contrast, the non-AP STAs may attempt to perform NPCA in the NPCA primary channel, assuming that all other conditions for performing NPCA are met. Since the AP does not switch to the NPCA channel/band, the non-AP STAs that switched to the NPCA band cannot communicate with the AP. Thus, the non-AP STAs may perform meaningless NPCA channel switching. Similarly, from the AP's perspective, since it views the primary channel as not being occupied, it may attempt to communicate with non-AP STAs in the primary channel. However, these non-AP STAs cannot respond to the AP because they have switched to the NPCA channel/band. This means that if the non-AP STAs are not able to recognize that the AP remains on the primary channel (has not switched to the NPCA channel/band), then this may result in unnecessary transmission attempts and power consumption.

An example of how the interpretation of OBSS signals among NPCA-capable wireless devices can differ is now provided. NPCA-capable wireless devices can consist of NPCA-capable APs and NPCA-capable non-AP STAs belonging to the same BSS. From a network topology perspective, it is unlikely that these AP and non-AP STAs are located at the exact same position. This means that their interpretations (e.g., detection and decoding ability) of the OBSS signals can differ depending on their physical location.

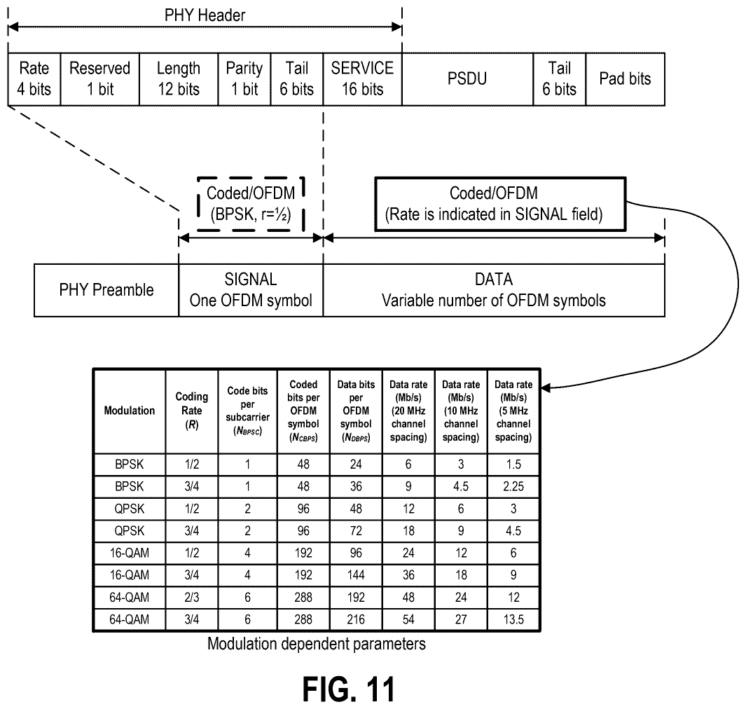

NPCA-capable STAs can perform NPCA after detecting an OBSS signal. The OBSS signal can be in the form of a PPDU carrying a control frame or data frame. Such signals may consist of a PHY preamble and MAC data (e.g., a MPDU). For PPDUs carrying a data frame, the PPDU may have one of the following PPDU formats: 1) a legacy (i.e., pre-UHR) PPDU format such as a non-HT PPDU format, HT PPDU format, VHT PPDU format, HE PPDU format, or EHT PPDU format; 2) a UHR PPDU format; or 3) a post-UHR PPDU format. In the case of a non-HT PPDU, according to existing IEEE 802.11 wireless networking standards, the PHY preamble of the non-HT PPDU must be transmitted using a BPSK modulation scheme with a ½ coding rate. The data payload of the non-HT PPDU can be transmitted using various modulation schemes (e.g., BPSK/QPSK/(16, 64)-QAM modulation schemes) with various coding rates, as shown in FIG. 11.

FIG. 11 is a diagram showing a non-HT PPDU format and modulation schemes that can be used for modulating different parts of the PPDU, according to some embodiments.

As shown in the diagram, the non-HT PPDU format includes a PHY preamble (12 symbols), a signal field (one OFDM symbol) (e.g., which is also considered as being part of the PHY preamble), and a data field (variable number of OFDM symbols). The signal field may include a rate field (4 bits), a reserved field (1 bit), a length field (12 bits), a parity field (1 bit), and a tail field (6 bits). The signal field may be modulated using a BPSK modulation scheme with a ½ coding rate. The data field may include a service field (16 bits), a PSDU field (which may include a set of MPDUs), a tail field (6 bits), and pad bits. The data field may be modulated using one of the modulation schemes and coding rates specified in the modulation dependent parameters table. The coding rate for the data field may be indicated in the signal field. Thus, the signal field, which carries critical information, may use a lower MCS (more reliable MCS) to ensure reliability.

Using different modulation schemes/orders between the preamble and the data payload can result in NPCA-capable wireless devices performing meaningless NPCA channel switching upon detecting an OBSS signal. An example situation illustrating this issue is described below.

Assume a wireless network environment that includes a basic service set (“MyBSS”) and an overlapping basic service set (OBSS). The MyBSS includes AP1, STA1-1, and STA1-2. The OBSS includes AP2, STA2-1, and STA2-2. AP2 may transmit a pre-HE legacy PPDU (e.g., HT PPDU) to STA2-1. The preamble and data payload of the pre-HE legacy PPDU may be modulated/encoded using different modulation schemes. For example, the preamble may be modulated/encoded using a BPSK modulation scheme, while the data payload may be modulated/encoded using a 64-QAM modulation scheme. It is assumed that AP1 and the STAs that belong to MyBSS (STA1-1 and STA1-2, which may be referred to as MyBSS STAs) are NPCA-capable STAs and have an OBSS listing to perform NPCA (e.g., NPCA may be performed when signals are transmitted by the OBSSs listed in the OBSS listing). The OBSS listing can be predefined between AP2 and MyBSS STAs through a beacon frame and/or probe response/request frame.

If the MyBSS STAs detect a signal transmitted by the OBSS, they may be able to perform NPCA. For example, the NPCA-capable STAs belonging to MyBSS that overhear the signal transmitted by AP2 (e.g., OBSS PPDU) can perform NPCA. However, in this example, it is assumed that STA1-1 may be able to decode the preamble and data payload of the PPDU transmitted by AP2, but AP1 and STA1-2 may only be able to decode the preamble of the PPDU (and not the data payload). This is because the data payload of the PPDU may be modulated using a higher modulation scheme/order than the preamble, resulting in relatively reduced coverage compared to the preamble. It is assumed that AP1 and STA1-2 are within the transmission range of the preamble of the pre-HE legacy PPDU transmitted by AP2 to STA2-1, but outside of the transmission range of the data payload, so they are only able to decode the preamble part. STA1-1 is closer to AP2 compared to AP1 and STA1-2 in terms of network topology, so it may be able to decode both the preamble and the data part of the PPDU transmitted by AP2. This coverage imbalance may result in the MyBSS AP/STAs making different NPCA channel switching decisions.

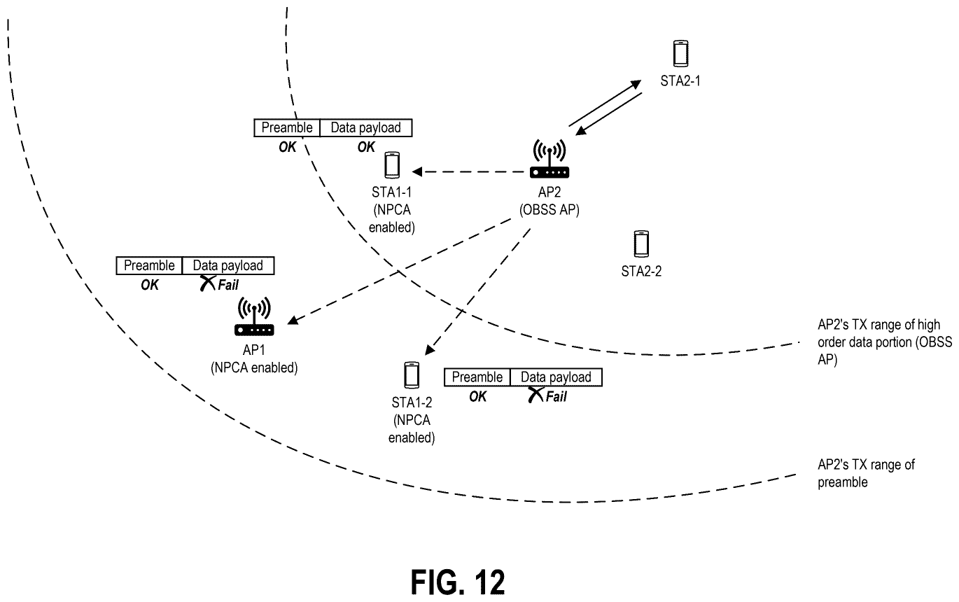

FIG. 12 is a diagram showing the coverage imbalance issue, according to some embodiments.

As shown in the diagram, AP2 may transmit a pre-HE legacy PPDU (e.g., HT) to STA2-1. NPCA-capable STAs (e.g., AP1, STA1-1, and STA1-2) may overhear the PPDU transmission and obtain the information necessary for performing NPCA. The necessary NPCA channel switching information may include the NPCA duration (e.g., the OBSS TXOP duration), BSS color information, etc., as mentioned above. For pre-HE legacy PPDUs (e.g., HT PPDUs), the PHY preamble includes a L-SIG field that includes a length field, but the PHY preamble does not include the TXOP duration information required for NPCA operation. Also, it is not possible to determine from the PHY preamble whether the OBSS PPDU is being transmitted by AP2 or by a non-AP STA within MyBSS. As such, to obtain the necessary NPCA channel switching information, the MAC header of the data payload needs to be examined. The MAC header may include a transmit address (TA) field, a receive address (RA) field, and a duration field. The TA field and RA field can help determine whether the overheard PPDU is an OBSS PPDU or not. Although the duration field may not necessarily indicate the TXOP duration, it can be treated as indicating the TXOP duration. Thus, for pre-HE legacy PPDUs (e.g., HT PPDUs), the information required for performing NPCA cannot be fully obtained from the PHY preamble, but requires examining the MAC header. However, in the example network topology shown in the diagram, AP1 and STA1-2 are unable to decode the data payload that contains the MAC header due to the network topology (i.e., the coverage imbalance). As a result, they are not able to obtain the necessary information for performing NPCA. As such, they may decide not to attempt channel switching for NPCA.

In the example network topology shown in the diagram, STA1-1 is able to decode both the PHY preamble and the MAC header of AP's PPDU. Thus, STA1-1 may be able to obtain the necessary information for performing NPCA from the MAC header. STA1-1 may decide whether to perform NPCA after decoding the MAC header. In this example, it is assumed that the MAC header contains the information necessary for performing NPCA and that STA1-1 decides to switch channels (to the NPCA primary channel) to perform NPCA.

Also, in the example network topology shown in the diagram, AP1 and STA1-2 fail to decode the MAC header of AP2′s PPDU and thus are not able to obtain the necessary information for performing NPCA. As such, in this example, it is assumed that AP1 and STA1-2 do not switch channels but remain on the primary channel.

The coverage imbalance issue may result in inefficient network behavior. AP1 remains on the primary channel, while STA1-1 switches to the NPCA primary channel to perform NPCA so it cannot communicate with AP1. This may result in increased battery consumption (i.e., power drain) for STA1-1. Also, AP1 may attempt to communicate with STA1-1 in the primary channel because AP1 may not be aware that STA1-1 has switched to the NPCA primary channel and assume that STA1-1 remains on the primary channel. Since STA1-1 has switched to the NPCA primary channel, however, it may not be able to detect AP1's transmissions. This may result in unnecessary transmissions by AP1.

As illustrated by the example provided above, NPCA-capable STAs may have different abilities to decode OBSS signals depending on the network topology. Some NPCA-capable STAs may only be able to decode the PHY preamble of the OBSS PPDU, while other NPCA STAs may be able to decode both the PHY preamble and the data payload of the OBSS PPDU. A solution is described herein that provides NPCA switching conditions/rules to avoid unnecessary NPCA channel switching. In an embodiment, NPCA-capable STAs determine whether to switch channels for NPCA (from the primary channel to the NPCA primary channel) using a preamble detection NPCA channel switching approach. With the preamble detection NPCA channel switching approach, NPCA-capable STAs may determine whether to switch to the NPCA primary channel based on information included in a preamble of an overheard PPDU. If the overheard PPDU does not have a PPDU format that provides necessary NPCA channel switching information, the NPCA-capable STA may decide not to perform NPCA. In an embodiment, NPCA-capable STAs determine whether to switch channels for NPCA using a control frame detection approach. With the control frame detection approach, NPCA-capable STAs may determine whether to switch to the NPCA primary channel based on information included in a control frame included in a data payload of an overheard PPDU. If the overheard PPDU does not carry a particular type of control frame (e.g., an initial control frame (ICF) or initial control response frame (ICR)) that provides necessary NPCA channel switching information, the NPCA-capable STA may decide not to perform NPCA.

To prevent unnecessary channel switching due to misaligned NPCA switching decisions, the use of the preamble detection NPCA channel switching approach or the control frame detection NPCA channel switching approach can be considered.

With the preamble detection NPCA channel switching approach, a wireless device may determine whether NPCA can be performed in the NPCA primary channel based on information included in a preamble of an overheard PPDU. PPDUs having a HE PPDU format, EHT PPDU format, or UHR PPDU format may provide necessary NPCA channel switching information in the preamble. For example, the preamble of HE PPDUs may include BSS color information, TXOP duration information, and other information in the HE-SIG field. The preamble of EHT PPDUs and UHR PPDU may include BSS color information, TXOP duration information, and other information in the U-SIG field. As such, in an embodiment, a wireless device may determine whether an overheard PPDU has a PPDU format that provides necessary NPCA channel switching information in the preamble of the PPDU. If the wireless device determines that the PPDU does not have a format that provides necessary NPCA channel switching information in the preamble of the PPDU, the wireless device may decide not to switch to the NPCA primary channel (and not perform NPCA).

With the control frame detection NPCA channel switching approach, a wireless device may determine whether NPCA can be performed in the NPCA primary channel based on information included in a control frame included in an overheard PPDU. As mentioned earlier, coverage imbalance issues may arise depending on the network topology. This means that a wireless devices' ability to decode the preamble of an overheard PPDU and the data payload of an overheard PPDU can be different. Thus, in an embodiment, a wireless device determines whether NPCA can be performed based on information included in an initial control frame (ICF) or initial control response frame (ICR). The ICF/ICR may be frames that contain necessary NPCA channel switching information (e.g., BSS color information, TXOP duration information, etc.) and be modulated using the same modulation scheme as the preamble. For example, to allow reliable decoding, the PHY preamble and data payload (which includes the ICF/ICR) of the PPDU can both be modulated using a BPSK modulation scheme with ½ coding rate. Thus, when the initial frame exchange consists of ICF/ICR, NPCA-capable wireless devices may be able to obtain necessary NPCA channel switching information from the ICF/ICR (in the data payload of an overheard PPDU) without having the coverage imbalance problem. If the wireless device determines that the PPDU does not carry a ICF/ICR, the wireless device may decide not to switch to the NPCA primary channel (and not perform NPCA).

Wireless devices may indicate which NPCA channel switching approach they will use or indicate which NPCA channel switching approach other wireless devices should use through beacon frame and/or probe request/response frames. This information can be indicated/shared along with information about the NPCA band and NPCA primary channel that should be used for NPCA. For example, a NPCA-capable AP may indicate to a non-AP STAs which NPCA channel switching approach the non-AP STAs should use in advance (e.g., through a bit included in beacon frames and/or probe request/response frames). If the AP indicates that the non-AP STAs should use the preamble detection NPCA channel switching approach, the non-AP STAs may determine whether the PHY preamble of an overheard OBSS PPDU contains the necessary NPCA channel switching information (e.g., has a HE, EHT, or UHR PPDU format) and perform NPCA after decoding the PHY preamble if the NPCA channel switching information satisfies the conditions for performing NPCA. If the AP indicates that the non-AP STAs should use the control frame detection NPCA channel switching approach, the non-AP STAs may determine whether an overheard PPDU carries a ICF/ICR and perform NPCA after decoding the ICF/ICR if the NPCA channel switching included in the ICF/ICR satisfies the conditions for performing NPCA.

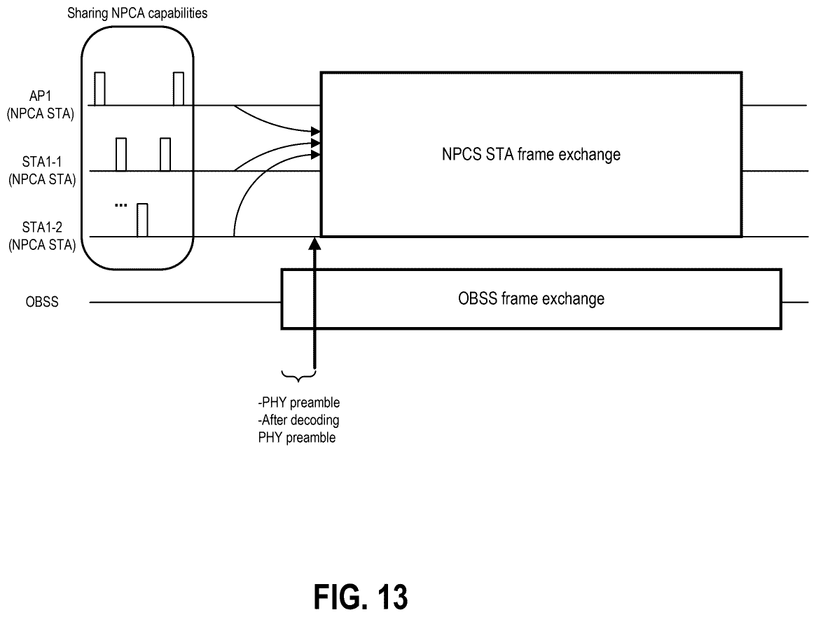

FIG. 13 is a diagram showing an example of a preamble detection NPCA channel switching approach, according to some embodiments. As shown in the diagram, AP1, STA1-1, and STA1-2 (which belong to the same BSS) may share NPCA capabilities with each other and agree to use a preamble detection NPCA channel switching approach. If AP1, STA1-1, and STA1-2 overhear an OBSS frame exchange, they may obtain necessary NPCA channel switching information from a PHY preamble of an OBSS PPDU upon detecting that the PPDU has a PPDU format that provides the necessary NPCA channel switching information in the preamble and determine whether NPCA can be performed based on the necessary NPCA channel switching information obtained from the PHY preamble. If AP1, STA1-1, and STA1-2 determine that NPCA can be performed, they may switch to the NPCA primary channel and perform NPCA (e.g., conduct a NPCA STA frame exchange).

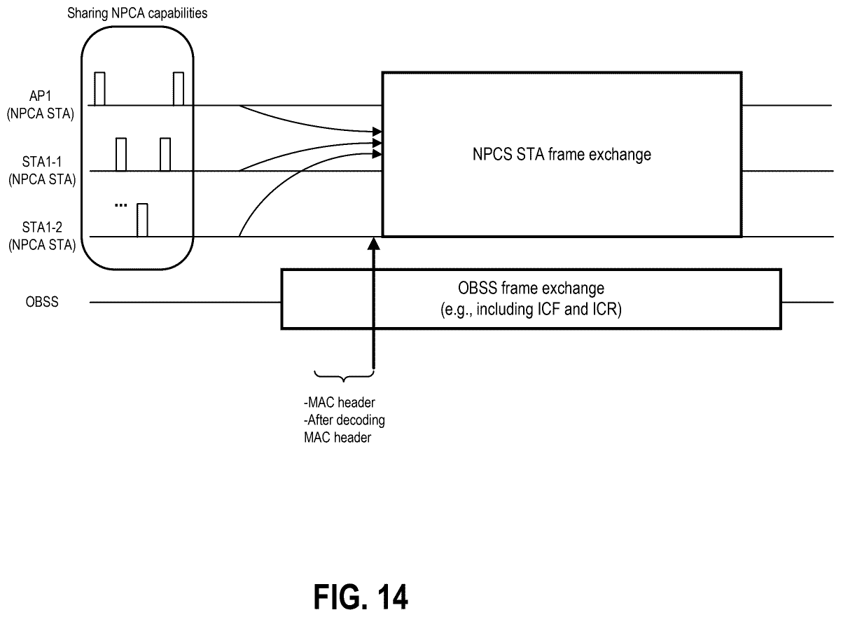

FIG. 14 is a diagram showing an example of a control frame detection NPCA channel switching approach, according to some embodiments. As shown in the diagram, AP1, STA1-1, and STA1-2 may share NPCA capabilities with each other and determine to use a control frame detection NPCA channel switching approach. If AP1, STA1-1, and STA1-2 overhear an OBSS frame exchange, they may obtain necessary NPCA channel switching information from a control frame carried in an OBSS PPDU (e.g., a ICF and/or ICR) upon detecting that the PPDU carries a control frame that provides the necessary NPCA channel switching information and determine whether NPCA can be performed based on the necessary NPCA channel switching information obtained from the control frame. If AP1, STA1-1, and STA1-2 determine that NPCA can be performed, they may switch to the NPCA primary channel and perform NPCA (e.g., conduct a NPCA STA frame exchange).

The present disclosure provides a solution to address the issue where NPCA-capable wireless devices make different/misaligned NPCA channel switching decisions due to coverage imbalance. The solution described herein may prevent the different/misaligned NPCA channel switching decisions that can cause unnecessary transmissions and power drain.

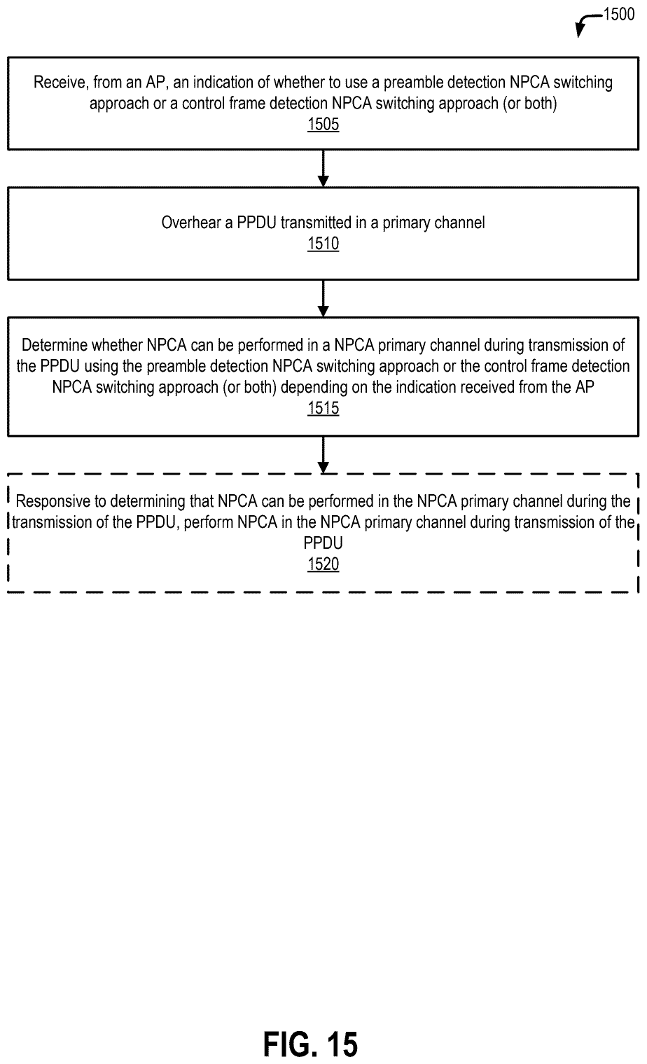

Turning now to FIG. 15, a method 1500 will be described for determining a NPCA channel switching approach to use, in accordance with an example embodiment. The method 1500 may be performed by a STA (e.g., that is implemented by wireless device 104).

Additionally, although shown in a particular order, in some embodiments the operations of the method 1500 (and the other methods shown in the other figures) may be performed in a different order. For example, although the operations of the method 1500 are shown in a sequential order, some of the operations may be performed in partially or entirely overlapping time periods.

At operation 1505, the STA receives, from an AP, an indication of whether to use a preamble detection NPCA switching approach or a control frame detection NPCA switching approach (or a combination of both).

At operation 1510, the STA overhears a PPDU transmitted in a primary channel.

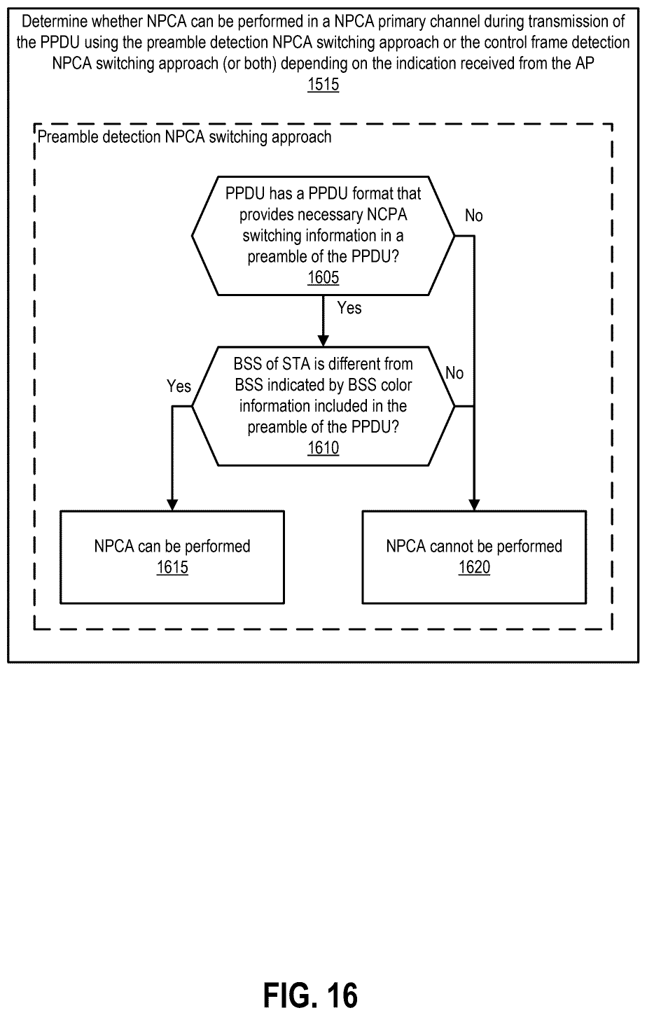

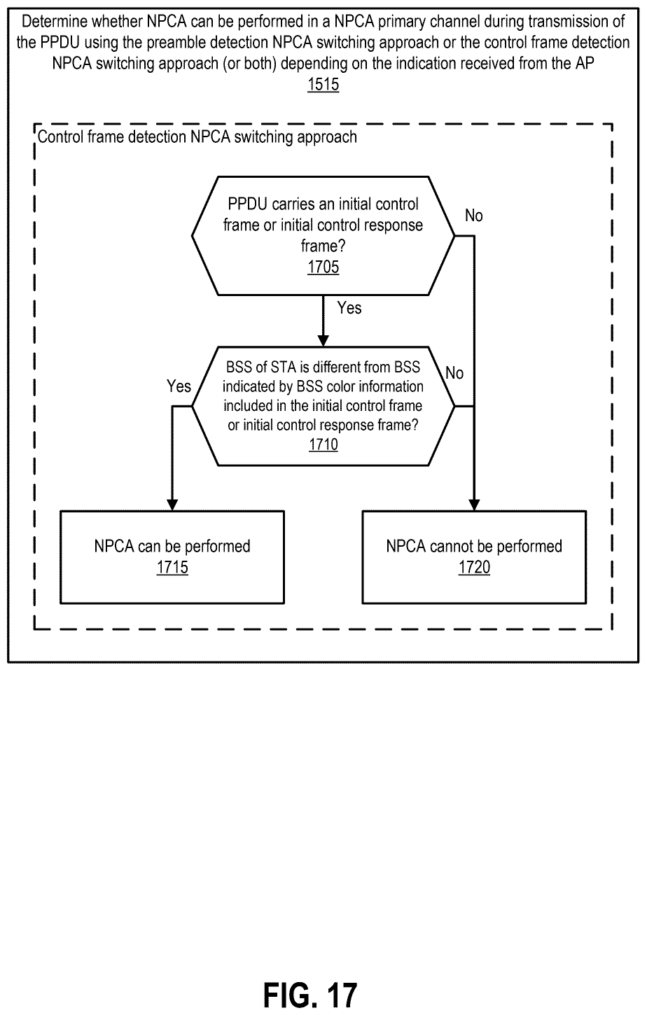

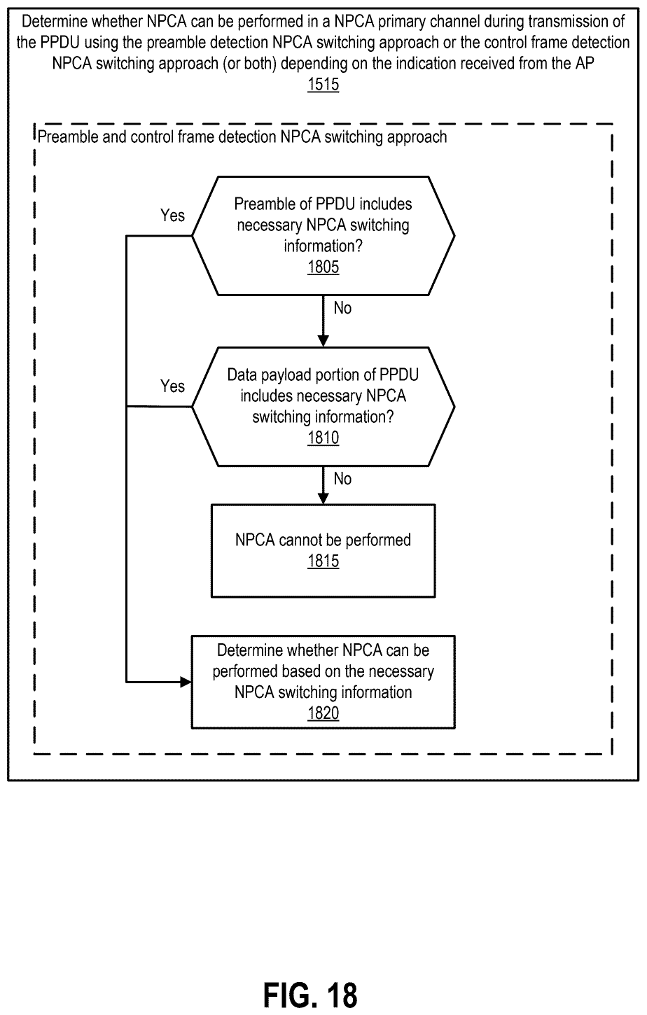

At operation 1515, the STA determines whether NPCA can be performed in a NPCA primary channel during transmission of the PPDU using the preamble detection NPCA channel switching approach or the control frame detection NPCA channel switching approach (or a combination of both) depending on the indication received from the AP. When using the preamble detection NPCA channel switching approach, operation 1515 may involve operations 1605-1620 shown in FIG. 16. When using the control frame detection NPCA channel switching approach, operation 1515 may involve operations 1705-1720 shown in FIG. 17. When using a combination of the preamble detection NPCA channel switching approach and the control frame detection NPCA channel switching approach, operation 1515 may involve operations 1805-1820 shown in FIG. 18.

In an embodiment, at operation 1520, responsive to determining that NPCA can be performed in the NPCA primary channel during the transmission of the PPDU, the STA performs NPCA in the NPCA primary channel during transmission of the PPDU. In an embodiment, the STA ends NPCA before a TXOP duration indicated by TXOP duration information included in the overheard PPDU expires. If the STA determines at operation 1515 that NPCA cannot be performed in the NPCA primary channel during the transmission of the PPDU, the STA may decide not to perform NPCA (and remain on the primary channel).

Turning now to FIG. 16, operations will be described for determining whether NPCA can be performed during transmission of a PPDU using a preamble detection NPCA channel switching approach, in accordance with an example embodiment.

As mentioned earlier, when using a preamble detection NPCA channel switching approach, operation 1515 may involve operations 1605-1620.

At operation 1605, the STA determines whether the PPDU has a PPDU format that provides necessary NCPA switching information in a (PHY) preamble of the PPDU. In an embodiment, the PPDU format that provides the necessary NPCA switching information in the preamble of the PPDU is a HE PPDU format, an EHT PPDU format, or a UHR PPDU format. In an embodiment, the necessary NPCA switching information includes BSS color information and TXOP duration information. If the STA determines that the PPDU has a PPDU format that provides necessary NCPA switching information in the preamble of the PPDU, the flow may move to operation 1610, where the STA determines whether the BSS of the STA is different from a BSS indicated by the BSS color information included in the preamble of the PPDU. If the STA determines that the BSS of the STA is different from a BSS indicated by the BSS color information included in the preamble of the PPDU, the flow may move to operation 1615, where the STA determines that NPCA can be performed (assuming any other conditions for performing NPCA are satisfied). If the STA determines that the PPDU does not have a PPDU format that provides necessary NCPA switching information in the preamble of the PPDU or that the BSS of the STA is the same as the BSS indicated by the BSS color information included in the preamble of the PPDU, the flow may move to operation 1620, where the STA determines that NPCA cannot be performed.

Turning now to FIG. 17, operations will be described for determining whether NPCA can be performed during transmission of a PPDU using a control frame detection NPCA channel switching approach, in accordance with an example embodiment.

As mentioned earlier, when using a control frame detection NPCA channel switching approach, operation 1515 may involve operations 1705-1720.

At operation 1705, the STA determines whether the PPDU carries an initial control frame or initial control response frame. If the STA determines that the PPDU carries an initial control frame or initial control response frame, the flow may move to operation 1710. In an embodiment, a data payload portion of the PPDU (which includes the initial control frame or initial control response frame) is modulated using a same MCS scheme as a preamble of the PPDU. In an embodiment, the initial control frame or the initial control response frame includes BSS color information and TXOP duration information. At operation 1710, the STA determines whether the BSS of the STA is different from a BSS indicated by the BSS color information included in the initial control frame or initial control response frame. If the STA determines that the BSS of the STA is different from a BSS indicated by the BSS color information included in the initial control frame or initial control response frame, the flow may move to operation 1715, where the STA determines that NPCA can be performed (assuming any other conditions for performing NPCA are satisfied). If the STA determines that the PPDU does not carry an initial control frame or initial control response frame or that the BSS of the STA is the same as the BSS indicated by the BSS color information included in the initial control frame or initial control response frame, the flow may move to operation 1720, where the STA determines that NPCA cannot be performed.

Turning now to FIG. 18, operations will be described for determining whether NPCA can be performed during transmission of a PPDU using a preamble and control frame detection NPCA channel switching approach, in accordance with an example embodiment.

As mentioned earlier, when using a preamble detection and control frame detection NPCA channel switching approach, operation 1515 may involve operations 1805-1820.

At operation 1805, the STA determines whether the preamble of PPDU includes necessary NPCA switching information (e.g., whether the PPDU has a PPDU format that provides the necessary NPCA switching information). If the STA determines that the preamble of the PPDU includes necessary NPCA switching information, the flow may move to operation 1820. Otherwise, if the STA determines that the preamble of the PPDU does not include necessary NPCA switching information, the flow may move to operation 1810. At operation 1810, the STA determines whether a data payload portion of the PPDU includes necessary NPCA switching information. If the STA determines that the data payload portion of the PPDU includes necessary NPCA switching information, the flow may move to operation 1820. Otherwise, if the STA determines that the data payload portion of the PPDU does not include necessary NPCA switching information, the flow may move to operation 1815, where the STA determines that NPCA cannot be performed. If the flow moves to operation 1820, the STA determines whether NPCA can be performed based on the necessary NPCA switching information (e.g., which may have been obtained from the preamble or data payload).

It should be appreciated that a STA can switch between using the preamble detection NPCA channel switching approach, the control frame detection NPCA channel switching approach, and/or the preamble detection and control frame detection NPCA channel switching approach depending on instructions received from the AP. That is, the NPCA channel switching approached used by the STA can change dynamically.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a station (STA), the method comprising:
receiving, from an access point (AP), an indication of whether to use a preamble detection NPCA channel switching approach or a control frame detection NPCA channel switching approach;
overhearing a PPDU transmitted in a primary channel; and
determining whether NPCA can be performed in a NPCA primary channel during transmission of the PPDU using the preamble detection NPCA channel switching approach or the control frame detection NPCA channel switching approach depending on the indication received from the AP.

2. The method of claim 1, wherein the indication received from the AP indicates that the STA should use the preamble detection NPCA channel switching approach, wherein the determining whether NPCA can be performed comprises determining whether the PPDU has a PPDU format that provides necessary NPCA channel switching information in a preamble of the PPDU.

3. The method of claim 2, wherein the PPDU format that provides the necessary NPCA channel switching information in the preamble of the PPDU is a high efficiency (HE) PPDU format, an extremely high throughput (EHT) PPDU format, or an ultra high reliability (UHR) PPDU format.

4. The method of claim 2, wherein the necessary NPCA channel switching information includes basic service set (BSS) color information and transmission opportunity (TXOP) duration information.

5. The method of claim 4, wherein the STA determines that the PPDU has a PPDU format that provides the necessary NPCA channel switching information, wherein the determining whether NPCA can be performed further comprises determining whether a basic service set (BSS) of the STA is different from a BSS indicated by BSS color information included in the preamble of the PPDU.

6. The method of claim 5, wherein the STA determines that NPCA can be performed because the BSS of the STA is different from the BSS indicated by the BSS color information.

7. The method of claim 6, further comprising:
performing NPCA in the NPCA primary channel during the transmission of the PPDU.

8. The method of claim 7, further comprising:
ending the NPCA before a TXOP duration indicated by the TXOP duration information expires.

9. The method of claim 2, wherein the STA determines that NPCA cannot be performed because the PPDU does not have a PPDU format that provides the necessary NPCA channel switching information.

10. The method of claim 1, wherein the indication received from the AP indicates that the STA should use a control frame detection NPCA channel switching approach, wherein the determining whether NPCA can be performed comprises determining whether the PPDU carries an initial control frame or an initial control response frame.

11. The method of claim 10, wherein a data payload portion of the PPDU is modulated using a same modulation coding scheme (MCS) as a preamble of the PPDU.

12. The method of claim 11, wherein the initial control frame or the initial control response frame includes basic service set (BSS) color information and transmission opportunity (TXOP) duration information.

13. The method of claim 12, wherein the STA determines that the PPDU carries the initial control frame or the initial control response frame, wherein the determining whether NPCA can be performed further comprises determining whether a BSS of the STA is different from a BSS indicated by the BSS color information.

14. The method of claim 13, wherein the STA determines that NPCA can be performed because the BSS of the STA is different from the BSS indicated by the BSS color information.

15. The method of claim 14, further comprising:
performing NPCA in the NPCA primary channel during the transmission of the PPDU.

16. The method of claim 7, further comprising:
ending the NPCA before a TXOP duration indicated by the TXOP duration information expires.

17. The method of claim 1, further comprising:
receiving, from the AP, an indication to use a preamble and control frame detection NPCA channel switching approach;
overhearing a second PPDU transmitted in the primary channel; and
determining whether NPCA can be performed in the NPCA primary channel during transmission of the second PPDU using the preamble and control frame detection NPCA channel switching approach.

18. The method of claim 17, wherein the determining whether NPCA can be performed using the preamble and control frame detection NPCA channel switching approach comprises:
determining whether necessary NPCA channel switching information can be obtained from a preamble of the PPDU; and
responsive to determining that the necessary NPCA channel switching information cannot be obtained from the preamble of the PPDU, obtaining the necessary NPCA channel switching information from a data payload portion of the PPDU.

19. The method of claim 18, further comprising:
responsive to determining that NPCA can be performed in the NPCA primary channel during transmission of the second PPDU, performing NPCA in the NPCA primary channel during the transmission of the second PPDU.

20. A wireless device to function as a station (STA), the wireless device comprising:
a radio frequency transceiver;
a memory device storing a set of instructions; and
a processor coupled to the memory device, wherein the set of instructions, when executed by the processor, causes the wireless device to:
receive, from an access point (AP), an indication of whether to use a preamble detection NPCA channel switching approach or a control frame detection NPCA channel switching approach;
overhear a PPDU transmitted in a primary channel; and
determine whether NPCA can be performed in a NPCA primary channel during transmission of the PPDU using the preamble detection NPCA channel switching approach or the control frame detection NPCA channel switching approach depending on the indication received from the AP.

21. The wireless device of claim 20, wherein the indication received from the AP indicates that the STA should use the preamble detection NPCA channel switching approach, wherein the determining whether NPCA can be performed comprises determining whether the PPDU has a PPDU format that provides necessary NPCA channel switching information in a preamble of the PPDU.
